(19) United States
(12) Patent Application Publication
(10) Pub. No.: US 2026/0091331 A1
(43) Pub. Date: Apr. 2, 2026

(54) SYSTEMS AND METHODS ASSOCIATED WITH DRAINING AN AIRPLANE OIL FILTER

(71) Applicant: BRYAN KNOWLTON, SAN ANGELO, TX (US)

(72) Inventor: BRYAN KNOWLTON, SAN ANGELO, TX (US)

(21) Appl. No.: 18/903,783

(22) Filed: Oct. 1, 2024

(51) Int. Cl. B01D 35/16; B01D 35/00; B01D 35/027; F01M 11/04; F16M 13/02

(52) U.S. Cl. CPC B01D 35/16; B01D 35/005; B01D 35/027; F01M 11/04; F16M 13/02; B01D 2201/0415

(57) ABSTRACT

Examples of the present disclosure are related to systems and methods for draining an airplane oil filter. More particularly, embodiments relate to tools to hold an oil can from an airplane upright while the oil filter is being drained.

### BACKGROUND INFORMATION

### Field of the Disclosure

Examples of the present disclosure are related to systems and methods for draining an airplane oil filter. More particularly, embodiments relate to tools to hold an oil canister filter for an airplane upright while the oil canister filter is being drained.

### Background

Oil filters are designed to remove contaminants from engine oil, transmission oil, lubricating oil, hydraulic oil, etc. Oil filters are used in many different types of machinery, with different shapes and sizes.

Oil filters for airplanes are generally cylindrical with a closed end and a nipple positioned on the opposite end. The closed end of the canister is generally planer; however, the nipple creates a profiled end that does not allow the canister to be held upright during draining. This creates issues when draining the oil from the oil filter, which can take several hours.

Accordingly, needs exist for more effective and efficient systems and methods for tools to hold an oil can from an airplane upright while the oil filter is being drained.

### SUMMARY

Embodiments disclosed herein describe systems and methods for a tool that is configured to hold a canister for an airplane oil filter upright while oil is being drained from the filter. The tool may include a holder, filter, and grid.

The holder may be a device that is configured to be held over a rim of a bucket, and to support the airplane oil filter cannister upright. The holder may also be configured to hold the filter and the grid while the oil filter is being drained. The holder may include a bottom orifice, tapered surface, shelf, inner sidewall, tubular conduits, and handle.

The bottom orifice may be positioned at the bottom of the holder and may be a cutout at the bottom of the holder that allows oil to be drained out of the holder and into a bucket. In embodiments, the bottom orifice may include a ledge that is configured to receive the filter.

The tapered surface may be a radially tapered surface with a slight downward slope from the shelf to the bottom orifice. This may allow oil to travel downward within the holder.

The shelf may be positioned between the inner sidewall and the tapered surface and may be a flat surface. In embodiments, the shelf may be configured to receive an outer diameter of the grid to secure the grid in place.

The inner sidewall of the holder may extend upward in a direction perpendicular to the shelf. The inner sidewall may be configured to support an outer circumference of the grid and/or an outer diameter of the airplane oil filter canister.

The tubular conduits may be tubular or substantially cylindrical projections that extend away from the inner sidewall on opposite sides of the handle. The tubular conduits may be configured to receive a hose, such that if engine oil is drained utilizing hoses, the hoses may be secured in place via the tubular conduits. In embodiments, the tubular conduits may extend from the upper rim of the holder to the shelf.

The handle may be a device that is configured to be positioned over the rim of a bucked to secure the holder to the bucket. The handle may include a radial ledge and a radial flange. The radial ledge is configured to be positioned over the rim of the bucket. The radial flange may extend in parallel to the inner sidewall of the holder. When the radial ledge is positioned over the rim of the bucket, the outer circumference of the holder and the inner surface of the radial flange may secure the holder in place.

The filter may be a circular device that is formed with a porous mesh, which oil can flow through while blocking larger solids, such as metal shavings. The filter may be configured to sit on the ledge within the holder below the grid. Responsive to oil flowing down through the holder, the oil may flow through the filter. In embodiments, filters may utilize different-sized meshes based on the type and weight of the oil used.

The grid is a substantially cylindrical device with a height that is shorter than its radius. The grid may have a series of radial openings and partitions that allow air to flow through the grid. A center of the grid may include a cylindrical cutout that is configured to receive and hold a nipple, nozzle, etc. of a cartridge of an oil filter. Specifically, the outer circumference of the nipple of the oil filter cartridge may be press-fit into the inner circumference of the cylindrical cutout to hold the oil filter cartridge upright. A body of the grid may include castling that includes a series of ridges and troughs. The castling may be configured to prevent a seal between the grid and the holder.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein reference numerals refer to like parts throughout the various views unless otherwise specified.

FIG. 1 depicts a tool configured to assist in draining an oil cartridge filter for an airplane, according to an embodiment.

FIG. 2 depicts a top view of the tool, according to an embodiment.

FIG. 3 depicts a rear view of the tool, according to an embodiment.

FIG. 4 depicts a side view of the tool, according to an embodiment.

FIGS. 5-7 depict various views of the tool, according to an embodiment.

FIGS. 8 and 9 depict an embodiment of the tool along with an oil filter canister.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art that the specific detail need not be employed to practice the present embodiments. In other instances, well-known materials or methods have not been described in detail to avoid obscuring the present embodiments.

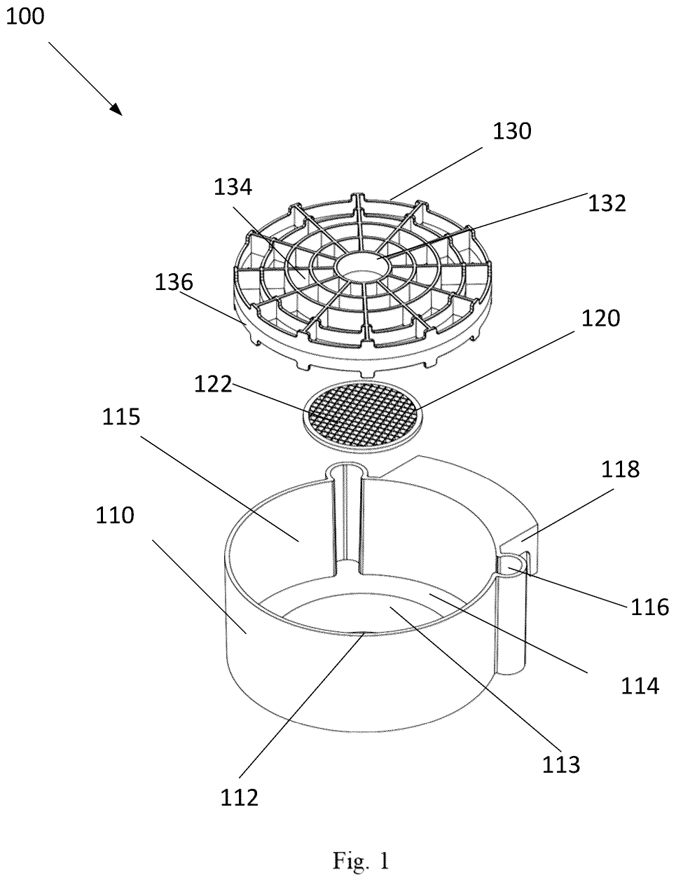

Turning now to FIG. 1, FIG. 1 depicts a tool 100 configured to assist in draining an oil cartridge filter for an airplane, according to an embodiment. Tool 100 may include a holder 110, filter 120, and grid 130.

The holder 110 may be a device that is configured to be held over the rim of a bucket, and to support the airplane oil filter canister upright, the filter 120, and the grid 130 while the oil filter is being drained. The holder 110 may include a bottom orifice 122, tapered surface 113, shelf 114, inner sidewall 115, tubular conduits 116, and handle 118.

The bottom orifice 112 may be positioned at the bottom of the holder 110, and may be a cutout at the bottom of the holder 110 that allows oil to be drained out of the holder 110 and into a bucket. In embodiments, the bottom orifice 112 may include a ledge that is configured to receive the filter. Furthermore, the circumference of bottom orifice 112 may be smaller than the upper opening of holder 110.

The tapered surface 113 may be a radially tapered surface with a slight downward slope from shelf 114 to the bottom orifice 112. This may allow oil to travel downward within the holder 110 while also allowing the bottom inner surfaces of grid 130 to not touch shelf 114. Furthermore, tapered surface 113 may also move bottom orifice 112 vertically away from shelf 114.

Shelf 114 may be positioned between the inner sidewall 115 and the tapered surface 113, wherein shelf 114 is a flat surface. In embodiments, shelf 114 may be configured to receive an outer diameter of the grid to secure the grid in place.

The inner sidewall 115 of the holder 110 may extend upward in a direction perpendicular to the shelf 113. The inner sidewall 115 may be configured to support an outer circumference of grid 130 and/or an outer diameter of the airplane oil filter canister (not shown). In embodiments, a diameter across inner sidewall 115 may be slightly larger than a diameter across grid 130.

The tubular conduits 118 may be tubular or substantially cylindrical projections that extend away from the inner sidewall 115 on opposite sides of the handle 118. The tubular conduit 118 may be configured to receive a hose, such that if engine oil is drained utilizing hoses, the hoses may be secured in place via the tubular conduits 118. In embodiments, the tubular conduits may extend from the upper rim of the holder 110 to the shelf 114. In embodiments, tubular conduits 118 may have the same diameter or may have different-sized diameters to accommodate hoses of different sizes. Specifically, hoses may be inserted into the tubular conduits 118, such that oil or other fluids may flow downward towards grid 130, through or around the radial openings and partitions within grid 130, through filter 120, and into a bucket.

The handle 118 may be a device that is configured to be positioned over the rim of a bucked to secure the holder 110 to the bucket. The handle 118 may include a radial ledge and a radial flange. The radial ledge is configured to be positioned over the rim of the bucket. The radial flange may extend in parallel to the inner sidewall 115 of the holder 110. When the radial ledge is positioned over the rim of the bucket, the outer circumference of the holder 110 and the inner surface of the radial flange may secure the holder in place. In other words, the relative geometries of handle 118 and the bucket may allow handle 118 to be press fit over the rim of the bucket.

The filter 120 may be a circular device that is formed with a porous mesh 122, which oil can flow through while blocking larger solids, such as metal shavings. The filter 120 may be configured to sit on the ledge within the holder 110 below the grid 120. In embodiments, an upper surface of the filter 120 may contact the lower surface of the grid 130. However, in other embodiments, the filter 120 and the grid 130 may not contact each other. Responsive to oil flowing down through the holder 110, the oil may flow through the filter 120, and into the bucket. In embodiments, filters 120 may utilize different-sized meshes 122 based on the type and weight of the oil used.

Grid 130 is a substantially cylindrical device with a height shorter than its radius. Grid 130 may have a series of radial openings and partitions 134 that allow air and fluids to flow through grid 130. A center of the grid may include a cylindrical cutout 132 that is configured to receive and hold a nipple, nozzle, etc. of a cartridge of an oil filter. Specifically, the outer circumference of the nipple of the oil filter cartridge may be press-fit into the inner circumference of the cylindrical cutout 132 to hold the oil filter cartridge upright. A body and outer circumference of grid 130 may include castling 136 which includes a series of ridges and troughs. The castling 136 may be configured to prevent a seal from forming between the grid 130 and the holder 130. In embodiments, the series of radial openings and partitions 134 may have much larger openings than the mesh 122 of filter 120.

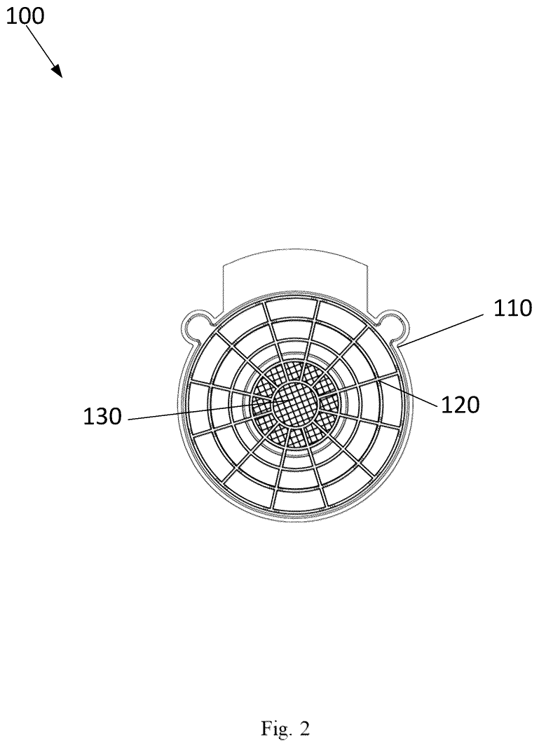

FIG. 2 depicts a top view of tool 100, according to an embodiment. As depicted in FIG. 2 filter 120 and grid 130 may be configured to sit within holder 110.

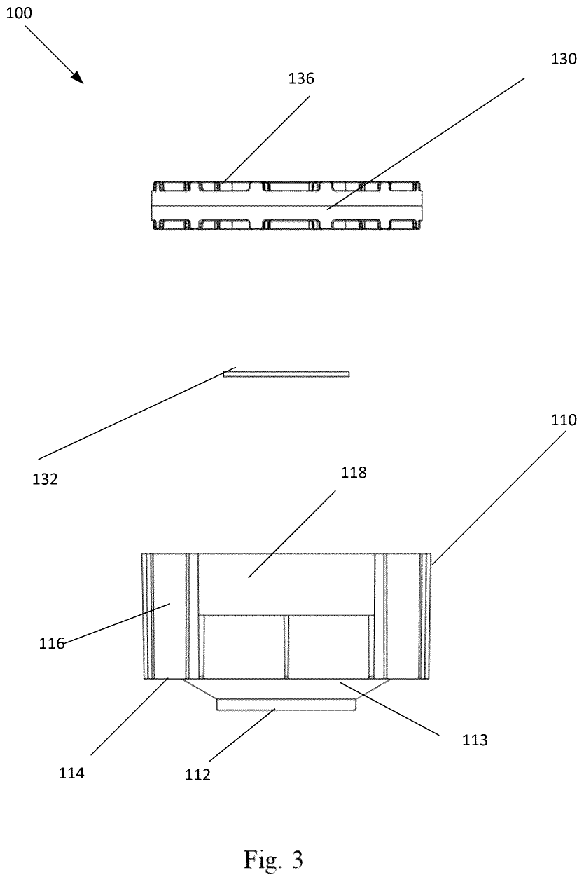

FIG. 3 depicts a rear view of tool 100, according to an embodiment.

As depicted in FIG. 3, the castling 136 on grid 130 may be positioned on both the upper surface and lower surface of grid 130. This may allow grid 130 to operate in either a top-down or bottom down orientation.

As further depicted in FIG. 3, tapered surface 113 may be angled downward toward the bottom opening 112 to vertically offset shelf 114 from the bottom opening 112. This may allow outer portions of grid 130 to sit on shelf 114, while inner portions of grid 130 may not sit on shelf 114.

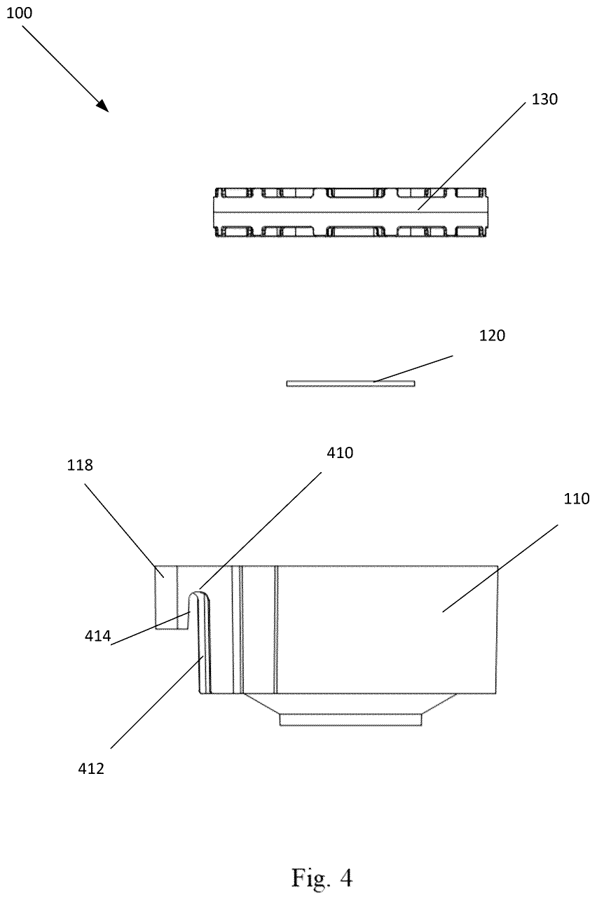

FIG. 4 depicts a side view of tool 100, according to an embodiment.

As depicted in FIG. 4, handle 118 may include a radial ledge 414 positioned between a curved outer surface 412 of holder 110 and a curved inner surface of flange 414. This may enable radial ledge 414 to be positioned over the rim of a bucket to secure holder 110 in an upright position.

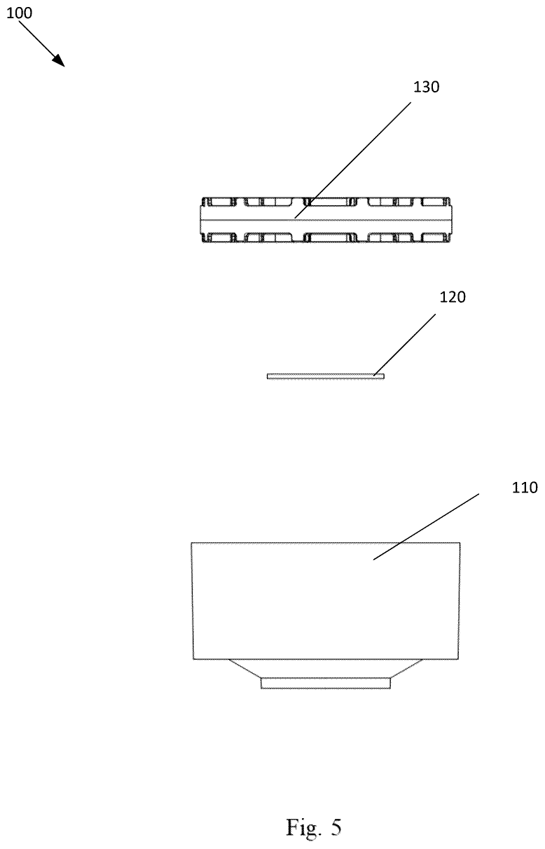

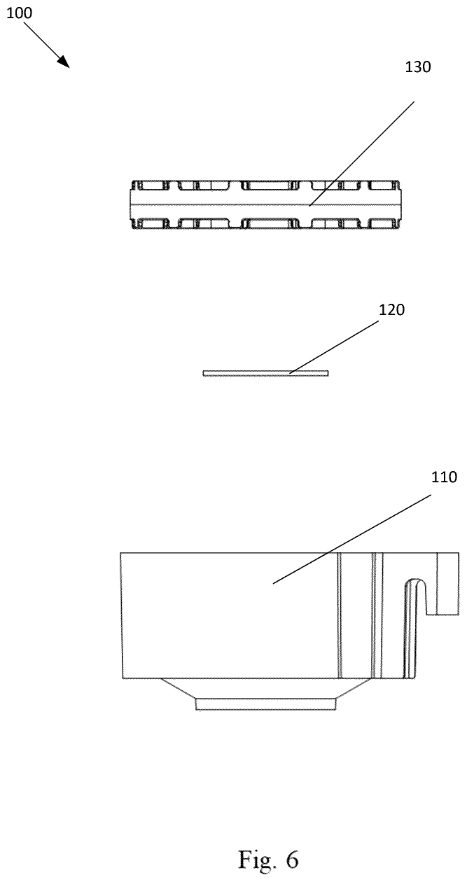

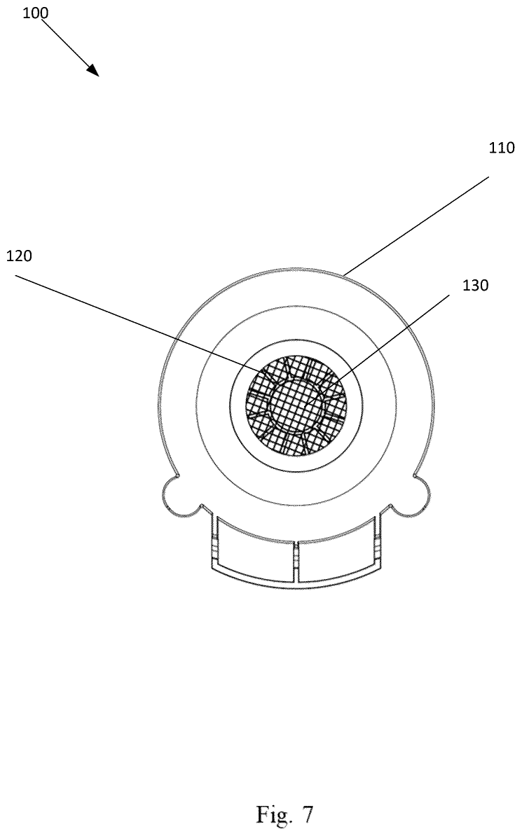

FIGS. 5-7 depict various views of tool 100, according to an embodiment.

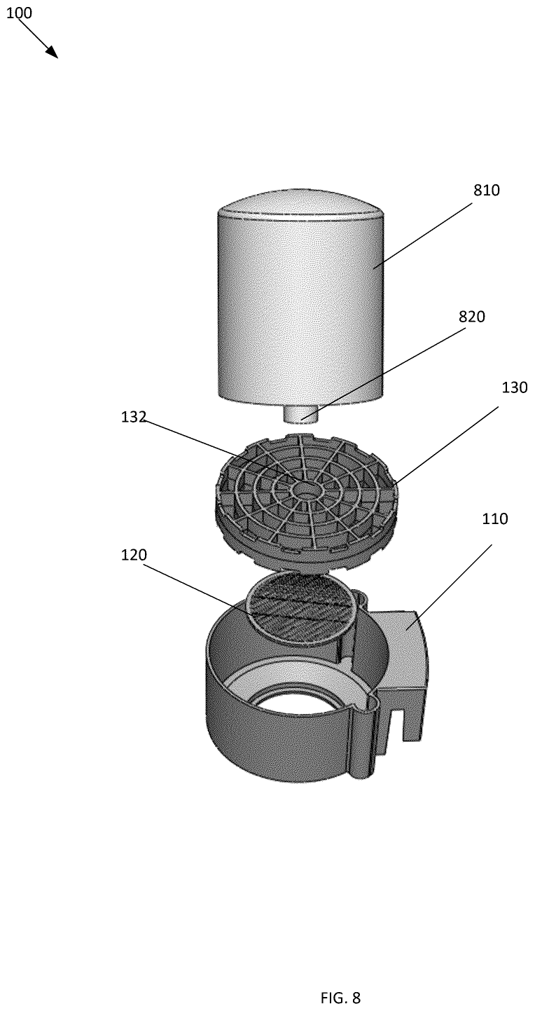

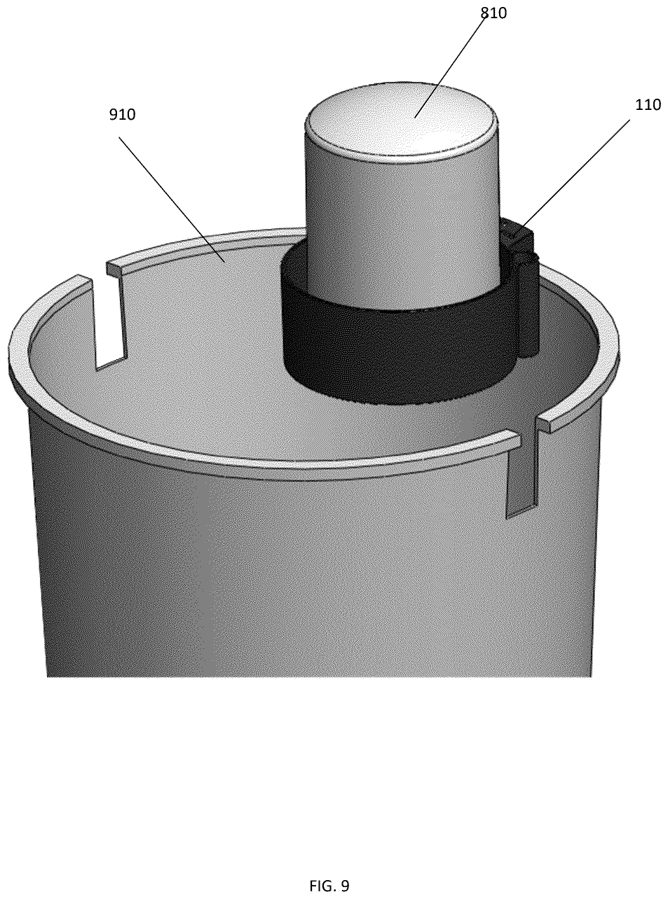

FIG. 8 depicts an embodiment of tool 100 along with an oil filter canister 810. As depicted in FIG. 8, canister 810 may include a nipple 820 that is substantially cylindrical. In embodiments, nipple 820 is configured to be inserted into center cutout 132, and grid 130 is configured to be positioned within holder 110. This may enable canister 810 to be held in an upright position on bucket 910, as depicted in FIG. 9.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A tool for draining oil out of a canister, the tool comprising:
a cylindrical grid with a center cutout, the center cutout being configured to receive a nipple of the canister;
a holder with a handle, shelf, and tapered surface, the handle is configured to be positioned over a rim of a bucket, wherein the grid is configured to sit on the shelf within the holder, and the tapered surface creates a downward slope from the shelf to a bottom opening of the holder, wherein when the grid is positioned on the shelf and the nipple of the canister is positioned into the center cutout the canister is held upright such that oil can be drained out of the canister.

2. The tool of claim 1, further comprising:
a filter configured to be positioned on a lower ledge of the holder, the filter is configured to filter solids out of drained oil.

3. The tool of claim 2, wherein a distance from the lower ledge to the shelf is shorter than a distance from the shelf to an upper rim of the holder.

4. The tool of claim 3, wherein a diameter of the shelf is less than half a diameter of the holder.

5. The tool of claim 4, wherein a diameter of the bottom opening of the holder is more than half the diameter of the holder.

6. The tool of claim 1, wherein an outer diameter of the grid includes castling, wherein the castling is configured to prevent a radial seal between a lower surface of the grid and the shelf within the holder.

7. The tool of claim 1, wherein the holder includes a plurality of tubular projections positioned on both sides of the handle, the tubular projections being configured to receive a corresponding hose.

8. The tool of claim 1, wherein the shelf is not configured to secure an entirety of a lower surface of the grid.

9. The tool of claim 1, wherein an inner diameter of the holder is longer than a height of the holder.

10. The tool of claim 9, wherein an inner circumference of the holder extends in a plane perpendicular to a plane of the shelf.
